(19) United States
(12) Patent Application Publication
(10) Pub. No.: US 2017/0158121 A1
(43) Pub. Date: Jun. 8, 2017

(54) LIGHTING SYSTEM FOR A VEHICLE SUN VISOR

(71) Applicant: Motus Integrated Technologies, Holland, MI (US)

(72) Inventor: Philip Allen Lehman, West Olive, MI (US)

(21) Appl. No.: 15/366,194

(22) Filed: Dec. 1, 2016

Related U.S. Application Data
(60) Provisional application No. 62/262,481, filed on Dec. 3, 2015.

(51) Int. Cl. B60Q 3/02; B60R 1/12; B60Q 3/00; B60R 16/03; B60R 16/02

(52) U.S. Cl. CPC B60Q 3/0226; B60Q 3/004; B60R 1/12; B60J 3/0282; B60R 16/005; B60R 16/03; B60R 2001/1269

(57) ABSTRACT

A lighting system for a vehicle sun visor includes a circuit board and an electrical contact formed on the circuit board. The lighting system also includes a switch having a finger, in which the finger is biased toward the electrical contact and configured to engage the electrical contact, and the finger is configured to be separated from the electrical contact via disposition of an element between the finger and the electrical contact, or in which the finger is biased away from the electrical contact, and the element is configured to drive the finger into engagement with the electrical contact. The element extends from a movable cover, the element is configured to engage the finger while the movable cover is in a closed position, and the element is configured to disengage the finger while the movable cover is in an open position.

### CROSS REFERENCE TO RELATED APPLICATION

This application claims priority from and the benefit of U.S. Provisional Application Ser. No. 62/262,481, entitled “LIGHTING SYSTEM FOR A VEHICLE SUN VISOR”, filed Dec. 3, 2015, which is hereby incorporated by reference in its entirety.

### BACKGROUND

The disclosure relates generally to a lighting system for a vehicle sun visor.

Many vehicles employ sun visors to shield occupants from sunlight, thereby enabling the occupants to focus on the surrounding environment. For example, certain vehicles include sun visors positioned adjacent to a top portion of the windshield to facilitate access by a driver and/or front passenger. Under certain lighting conditions, a driver may deploy the sun visor to reduce light transmission into the vehicle interior, thereby enabling the driver to focus on vehicle operations. Certain sun visors include a lighting system configure to illuminate a vehicle occupant during low light condition. Unfortunately, the components of the lighting system (e.g., light sources, lenses, a switch, etc.) may increase a thickness of the sun visor, thereby reducing occupant headroom and/or increasing a height of the vehicle roofline.

### BRIEF DESCRIPTION OF THE INVENTION

The present disclosure relates to a lighting system for a vehicle sun visor including a circuit board having a first surface and a second surface, opposite the first surface. An electrical contact is formed on the first surface. The lighting system also includes a switch having a finger, in which the finger is biased toward the electrical contact and configured to engage the electrical contact to complete an electrical circuit, and the finger is configured to be separated from the electrical contact via disposition of an element between the finger and the electrical contact to interrupt the electrical circuit, or in which the finger is biased away from the electrical contact to interrupt the electrical circuit, and the element is configured to drive the finger into engagement with the electrical contact to complete the electrical circuit. The element extends from a movable cover, the element is configured to engage the finger while the movable cover is in a closed position that covers a reflective element, and the element is configured to disengage the finger while the movable cover is in an open position that exposes at least a portion of the reflective element.

The present disclosure also relates to a lighting system for a vehicle sun visor including a light guide having a first reflective surface on a first lateral side of the light guide and a second reflective surface on a second lateral side of the light guide, opposite the first lateral side. The second reflective surface is positioned closer to a light emitting surface of the light guide than the first reflective surface, the light guide is configured to receive light through a light receiving surface on the first lateral side of the light guide, and the first reflective surface and the second reflective surface are configured to reflect the light though the light emitting surface.

The present disclosure further relates to a vehicle sun visor including a reflective element and a movable cover configured to cover the reflective element while in a closed position and to at least partially expose the reflective element to a vehicle interior while in an open position. The vehicle sun visor also includes a lighting system including a light transmissive element configured to emit light from a light emitting surface of the light transmissive element. The light emitting surface is exposed to the vehicle interior while the movable cover is in the closed position and in the open position.

### DRAWINGS

FIG. 1 is a perspective view of an embodiment of a vehicle that may include at least one sun visor having a lighting system.

FIG. 2 is a perspective view of a part of the interior of the vehicle of FIG. 1.

FIG. 3 is a perspective view of an embodiment of a sun visor having a lighting system.

FIG. 4 is a perspective view of a portion of the sun visor of FIG. 3, in which a power source door is in an open position.

FIG. 5 is a perspective view of a portion of the sun visor of FIG. 3, in which a movable cover is in a partially open position.

FIG. 6 is a perspective view of a portion of the sun visor of FIG. 3, in which the movable cover is in a closed position.

FIG. 7 is a side view of an embodiment of a circuit board and a switch that may be employed within the lighting system of the sun visor of FIG. 3.

FIG. 8 is a perspective view of the circuit board and the switch of FIG. 7.

FIG. 8A is a schematic view of an alternative embodiment of a switch that may be employed within the lighting system of the sun visor of FIG. 3.

FIG. 9 is a cross-sectional perspective view of an embodiment of a light guide that may be employed within the lighting system of the sun visor of FIG. 3.

### DETAILED DESCRIPTION

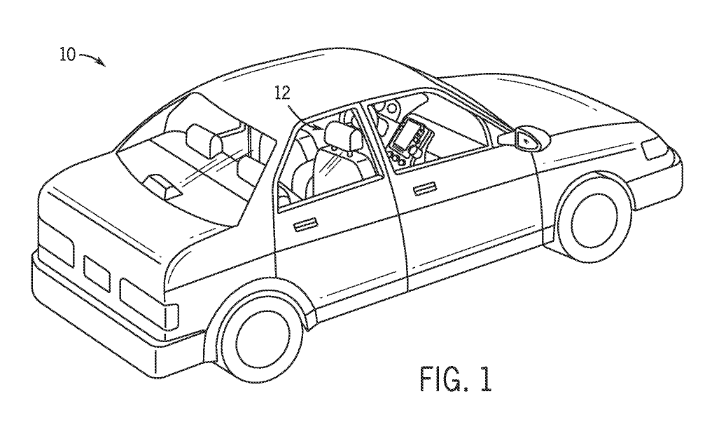

FIG. 1 is a perspective view of an embodiment of a vehicle 10 that may include at least one sun visor having a lighting system. In certain embodiments, the vehicle 10 may include sun visors within an interior 12 of the vehicle 10. In such embodiments, the sun visors are configured to shield vehicle occupants from sunlight. Each sun visor may include a lighting system configured to illuminate a vehicle occupant during low light conditions. In certain embodiments, the vehicle sun visor includes a reflective element and a movable cover configured to cover the reflective element while in a closed position and to at least partially expose the reflective element to the interior 12 of the vehicle 10 while in an open position. The vehicle sun visor also includes a lighting system having a light transmissive element (e.g., light guide, lens, etc.) configured to emit light from a light emitting surface of the light transmissive element. The light emitting surface is exposed to the interior 12 of the vehicle 10 while the movable cover is in the closed position and in the open position. Because the movable cover does not cover the light transmissive element, the thickness of the vehicle sun visor may be reduced, as compared to vehicle sun visors having a movable cover that covers the light emitting surface of a light transmissive element while in the closed position. As a result, headroom within the vehicle interior 12 may be increased, thereby enhancing passenger comfort. In addition, a thinner sun visor may facilitate construction of a vehicle having a lower roofline, thereby increasing fuel efficiency of the vehicle.

In certain embodiments, the vehicle sun visor includes a lighting system having a light guide with at least two reflective surfaces. The first reflective surface is positioned on a first lateral side of the light guide, and the second reflective surface is positioned on a second lateral side of the light guide, opposite the first lateral side. The second reflective surface is positioned closer to a light emitting surface of the light guide than the first reflective surface. The light guide is configured to receive light through a light receiving surface on the first lateral side of the light guide, and the first reflective surface and the second reflective surface are configured to reflect the light through the light emitting surface. The two reflective surfaces enable the lighting system to receive light from a single light source and to emit light from two separate areas of the light guide. Because the lighting system may include a single light source, the manufacturing cost of the lighting system may be reduced, as compared to a lighting system that utilizes two separate light sources to emit light from two separate areas of a sun visor. In certain embodiments, the light source may be positioned laterally outward from the light receiving surface and configured to emit light toward the light receiving surface. In such embodiments, the thickness of the vehicle sun visor may be reduced, as compared to sun visors having a high-profile light source positioned longitudinally behind a light guide or a lens. As a result, headroom within the vehicle interior 12 may be increased, thereby enhancing passenger comfort.

In certain embodiments, the vehicle sun visor includes a lighting system having a circuit board. The circuit board includes a first surface and a second surface, opposite the first surface, and an electrical contact is formed on the first surface. The lighting system also includes a switch having a finger, a first contact portion, and a second contact portion. The first and second contact portions are biased toward one another such that the first contact portion applies a first force to the first surface of the circuit board, and the second contact portion applies a second force to the second surface of the circuit board to couple the switch to the circuit board. In addition, the switch is formed from a single piece of material, the finger is biased toward the electrical contact and configured to contact the electrical contact to complete an electrical circuit, and the finger is configured to be separated from the electrical contact via disposition of an interrupter element between the finger and the electrical contact to interrupt the electrical circuit. Because the switch is formed from a single piece of material and coupled to the circuit board by a clamping force, the manufacturing cost of the vehicle sun visor may be reduced, as compared to sun visors having more complex switch assemblies.

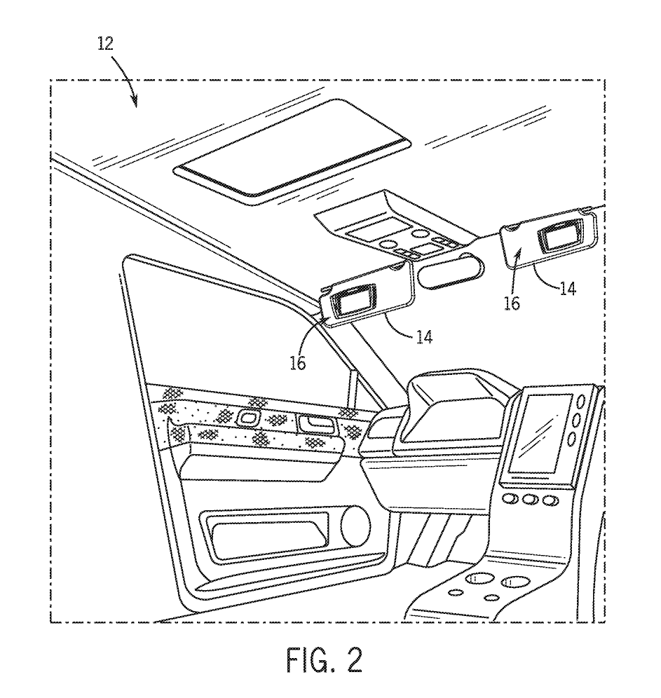

FIG. 2 is a perspective view of a part of the interior 12 of the vehicle 10 of FIG. 1. As illustrated, the vehicle interior 12 includes a sun visor 14 having a lighting system 16. As previously discussed, the lighting system may facilitate a reduction in the thickness of the sun visor 14 by utilizing a movable cover that does not block the light emitting surface of a light transmissive element and/or positioning a light source laterally outward from a light receiving surface of a light guide. Reducing the thickness of the sun visor may increase headroom and/or facilitate construction of a vehicle having a lower roofline. In addition, the lighting system may reduce the cost of the sun visor 14 by utilizing a single-piece switch that clamps to a respective circuit board and/or a light guide that receives light from a single light source and creates the appearance of multiple light sources.

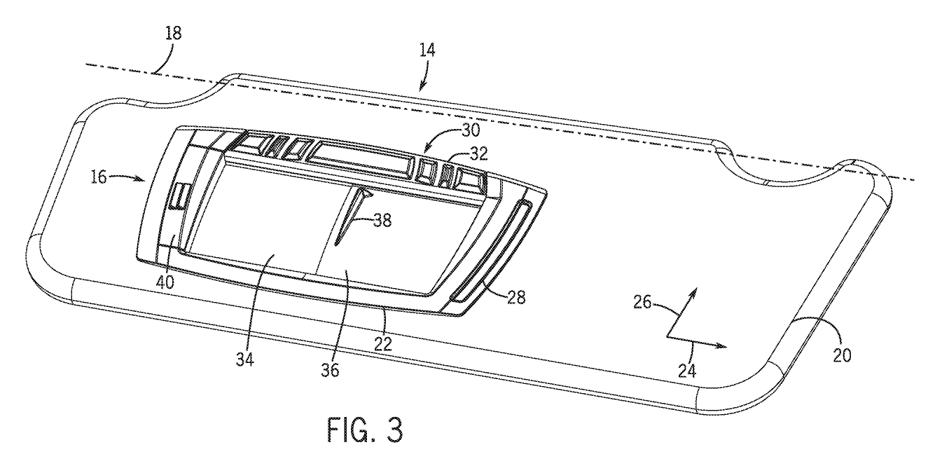

FIG. 3 is a perspective view of an embodiment of a sun visor 14 having a lighting system 16. In certain embodiments, the sun visor 14 is configured to rotate about a rotational axis 18 between a stowage position (e.g., parallel to a headliner of the vehicle interior) and a usage position (e.g., deployed to reduce light transmission into the vehicle interior). In the illustrated embodiment, the sun visor 14 includes a core 20 and a bezel 22 coupled to the core 20. The core 20 may be formed from any suitable material, such as expanded polypropylene and/or compression formed materials, among others. In certain embodiments, the core 20 is formed from two (e.g., polymeric) shells coupled to one another. As illustrated, the bezel 22 extends in a lateral direction 24 (e.g., parallel to the rotational axis 18) and in a vertical direction 26 (e.g., perpendicular to the rotational axis 18 along a face of the core 20) relative to the core 20. In the illustrated embodiment, the bezel 22 includes a slot 28 configured to retain one or more substantially flat items (e.g., business cards, access cards, etc.).

In the illustrated embodiment, a recess 30 is formed in the vertically upward portion of the bezel 22 (e.g., proximate to the rotational axis 18), and a light transmissive element, such as the illustrated light guide 32, is disposed within the recess 30. As discussed in detail below, the light guide 32 is configured to emit light toward a vehicle occupant to illuminate the vehicle occupant in low light conditions. The bezel 22 and the light guide 32 surround a reflective element 34 of the vehicle sun visor 14. The reflective element 34 (e.g., vanity mirror) may include a mirror, a polished sheet of metal, or a reflective film disposed onto a substrate, for example. A reflective surface of the reflective element 34 faces the vehicle interior to enable a vehicle occupant to view a reflection in the reflective element 34.

In the illustrated embodiment, the vehicle sun visor 14 includes a movable cover 36 (e.g., vanity mirror door) configured to cover the reflective element 34 while in a closed position and to at least partially expose the reflective element 34 while in an open position. As illustrated, the movable cover 36 is in an open position exposing about half of the reflective element 34. However, the movable cover 36 is configured to slide in the lateral direction 24 (e.g., along tracks within the core 20) between the closed position that covers the reflective element 34 and a fully open position that exposes at least a substantial portion of the reflective element 34. While the movable cover 36 is configured to slide in the lateral direction 24 in the illustrated embodiment, it should be appreciated that in alternative embodiments, the movable cover may be configured to slide in the vertical direction 26, or in any other suitable direction. In the illustrated embodiment, the movable cover 36 includes a handle 38 configured to enable a vehicle occupant to move the movable cover 36 between the open and closed positions. However, it should be appreciated that in alternative embodiments, the movable cover may include another feature (e.g., recess, protrusion, etc.) configured to enable a vehicle occupant to move the movable cover. In further embodiments, the movable cover may be driven to move between the open and closed positions by an electric motor, for example.

In certain embodiments, the lighting system 16 includes a light source configured to illuminate the light guide 32 and a power source configured to provide electrical power to the light source. In the illustrated embodiment, the power source is configured to be removed and replaced (e.g., if the electrical output from the power source decreases below a minimum power level). In the illustrated embodiment, the vehicle sun visor 14 includes a power source door 40 configured to block access to the power source while in a closed position and to facilitate access to the power source while in an open position. The power source door 40 is configured to couple to the bezel 22 while in the closed position, and the power source door 40 is configured to release from the bezel 22 (e.g., via application of force in the lateral direction 24) to transition to the open position. In the illustrated embodiment, the power source door 40 and the light guide 32 are separate elements of the vehicle sun visor 14.

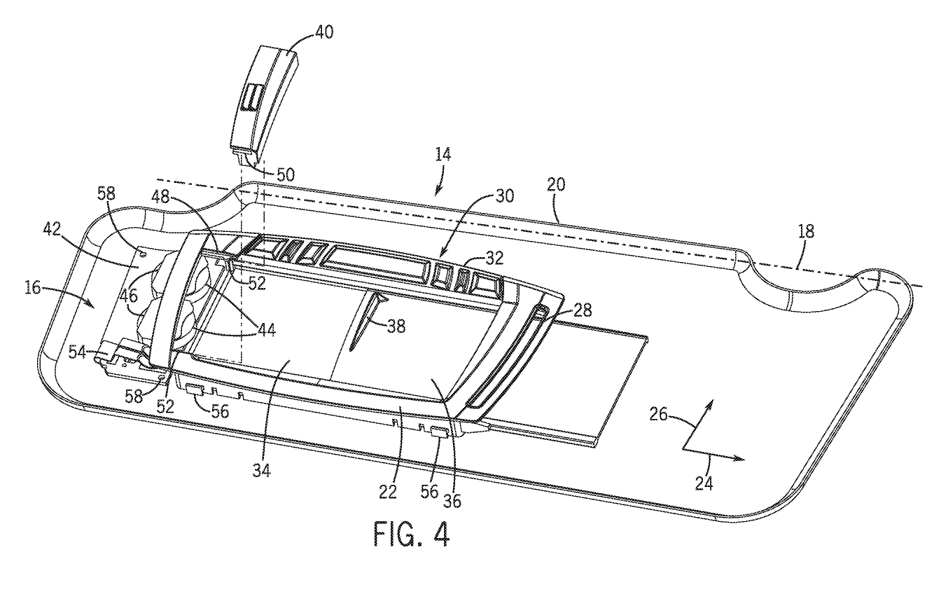

FIG. 4 is a perspective view of a portion of the sun visor of FIG. 3, in which the power source door 40 is in the open position. With the power source door 40 in the open position (e.g., released from the bezel 22), a circuit board 42 and the power source 44 are exposed, thereby providing access to the power source 44. In the illustrated embodiment, the power source 44 includes two batteries mounted to the circuit board 42 by respective clips 46. However, it should be appreciated that in alternative embodiments, the power source may include more or fewer batteries (e.g., 1, 2, 3, 4, 5, 6, or more), and the batteries may be mounted to the circuit board, or the batteries may be electrically coupled to the circuit board from a location remote from the circuit board. In addition, it should be appreciated that other power sources, such as capacitors, may be utilized in alternative embodiments.

With the power source door 40 in the open position, the batteries may be removed from the clips 46 via translation in the lateral direction 24. Replacement batteries may then be inserted between the circuit board 42 and the clips 46, and the power source door may be transitioned to the closed position (e.g., coupled to the bezel 22). In the illustrated embodiment, the bezel 22 includes rails 48 configured to interface with corresponding slots 50 in the power source door 40, which are positioned on opposite vertical sides of the power source door 40. Each rail 48 includes a respective protrusion 52 configured to interface with a corresponding recess in the power source door 40. With the power source door 40 in the closed position, interaction between the protrusions 52 and the recesses biases the power source door 40 toward the closed position while the power source door 40 is in the closed position. However, applying a force to the power source door 40 in the lateral direction 24 sufficient to overcome the bias drives the power source door toward the open position (e.g., by sliding along the rails 48).

As discussed in detail below, the lighting system 16 includes a switch 54 configured to selectively complete an electrical circuit that provides electrical current from the power source 44 to a light source, thereby illuminating the light guide 32. In addition, the switch 54 is configured to interrupt the electrical circuit, thereby terminating electrical current to the light source. In certain embodiments, the switch is configured to complete the electrical circuit while the movable cover 36 is in the open position and to interrupt the electrical circuit while the movable cover 36 is in the closed position. Accordingly, the light guide 32 is only illuminated while the movable cover 36 is in the open position.

In the illustrated embodiment, the bezel 22 is coupled to the core 20 by clips 56. The clips 56 extend from the core 20 (e.g., integrally molded with the core) and are configured to engage corresponding recesses or openings within the bezel 22. In addition, the circuit board 42 is configured to be secured to the core 20 by fasteners that extend through openings 58 in the circuit board 42 and engage the core 20. It should be appreciated that the bezel 22 and/or the circuit board 42 may be coupled to the core 20 by other techniques (e.g., adhesive, vibration welding, etc.) in alternative embodiments. In addition, in certain embodiments, the circuit board 42 may be coupled to the bezel 22 (e.g., instead of the core 20 or in addition to the core 20).

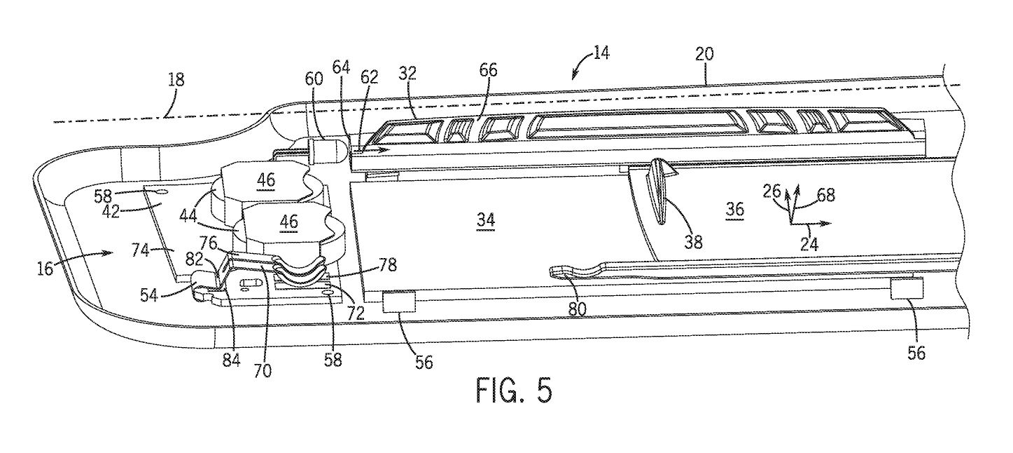

FIG. 5 is a perspective view of a portion of the sun visor 14 of FIG. 3, in which the movable cover 36 is in an open (e.g., partially open) position. In the illustrated embodiment, the lighting system 16 includes a light source 60, such as the illustrated light emitting diode (LED), mounted to the circuit board 42. The light source 60 is configured to emit light 62 in the lateral direction 24 toward a light receiving surface 64 of the light guide 32. As discussed in detail below, the light guide 32 is configured to direct the light from the light receiving surface 64 through a light emitting surface 66, such that the light guide 32 emits light in a longitudinal direction 68 toward the vehicle interior (e.g., toward a vehicle occupant). In certain embodiments, the circuit board 42 includes circuitry configured to control the light source 60. For example, the circuitry may be configured to gradually increase the brightness of the light source upon activation of the light source, to gradually decrease the brightness of the light source upon deactivation of the light source, to automatically deactivate the light source after a predetermined duration, or a combination thereof.

In the illustrated embodiment, the light receiving surface 64 is positioned on a lateral side of the light guide 32, and the light source 60 is positioned laterally outward from the light guide. In addition, the circuit board 42, the power source 44, and the switch 54 are positioned laterally outward from the reflective element 34. As a result, the thickness of the vehicle sun visor 14 may be reduced, as compared to sun visors in which a high-profile light source is positioned behind a light guide or lens along the longitudinal direction, and/or a circuit board is positioned longitudinally behind the reflective element. Furthermore, in the illustrated embodiment, the light guide 32 is positioned forward of the movable cover 36 along the longitudinal direction 68. Accordingly, the movable cover 36 does not block the light emitting surface 66 of the light guide 32 while the cover is in the open position or the closed position. As a result, the light emitting surface 66 of the light guide 32 is exposed to the vehicle interior while the movable cover 36 is in the closed position and in the open position. Because the movable cover 36 does not cover the light guide, the thickness of the vehicle sun visor 14 may be reduced, as compared to vehicle sun visors having a movable cover that covers the light emitting surface of a light transmissive element (e.g., a light guide, a lens, etc.) while in the closed position. The thinner vehicle sun visor 14 may increase headroom within the vehicle interior, thereby enhancing passenger comfort. In addition, the thinner vehicle sun visor 14 may facilitate construction of a vehicle having a lower roofline, thereby increasing fuel efficiency of the vehicle.

While the light source 60 is an LED in the illustrated embodiment, it should be appreciated that in alternative embodiments, the light source may be an incandescent bulb, a fluorescent bulb, or any other suitable type of light source. Furthermore, while the light source 60 is mounted to the circuit board 42 in the illustrated embodiment, it should be appreciated that in alternative embodiments, the light source may be electrically coupled to the circuit board and located remote from the circuit board. Furthermore, in certain embodiments, the lighting system may include a lens positioned between the light source and the light receiving surface of the light guide to focus the light entering the light guide.

In the illustrated embodiment, the switch 54 is formed from a single piece of electrically conductive material, such as metal (e.g., copper) or an electrically conductive plastic. In embodiments in which the switch is formed from metal, the switch 54 may be a single stamping. In the illustrated embodiment, the switch 54 includes a finger (e.g., first finger 70), and an electrical contact (e.g., first electrical contact 72) is formed on a first surface 74 of the circuit board 42. The first finger 70 is biased toward the first electrical contact 72. In addition, the switch 54 includes a second finger 76, and a second electrical contact 78 is formed on the first surface 74 of the circuit board 42. The switch 54 is configured to conduct electrical current between the first electrical contact 72 and the second electrical contact 78 while the fingers 70 and 76 are in contact with the electrical contacts 72 and 78. While the switch is formed from a single piece of material in the illustrated embodiment, it should be appreciated that in alternative embodiments, the switch may be formed from multiple elements (e.g., conductive elements, non-conductive elements, etc.) coupled to one another.

The first finger 70 is configured to contact the first electrical contact 72 to complete an electrical circuit. In the illustrated embodiment, the electrical circuit electrically connects the power source 44 to the light source 60. Accordingly, while the first finger 70 is in contact with the first electrical contact 72, electrical current flows from the power source 44 through the switch 54 (e.g., from the first electrical contact 72 to the second electrical contact 78) to the light source 60, thereby illuminating the light source 60. In addition, the first finger 70 is configured to be separated from the first electrical contact 72 via disposition of an element (e.g., interrupter element 80) between the first finger 70 and the first electrical contact 72 to interrupt the electrical circuit. In the illustrated embodiment, the interrupter element 80 extends from the movable cover 36 (e.g., integrally formed with the movable cover 36). Accordingly, with the movable cover 36 in the illustrated open position, the first finger 70 contacts the first electrical contact 72, thereby completing the electrical circuit. However, with the movable cover 36 in the closed position, the interrupter element 80 is positioned between the first finger 70 and the first electrical contact 72, thereby interrupting the electrical circuit. As a result, the light source 60 is illuminated while the movable cover 36 is in the open position, and the light source 60 is deactivated while the movable cover 36 is in the closed position.

In the illustrated embodiment, the switch 54 includes a first contact portion 82, and a third electrical contact is formed on the first surface 74 of the circuit board 42. As discussed in detail below, the first contact portion 82 applies a force to the first surface 74 of the circuit board 42 to couple the switch 54 to the circuit board 42. In addition, the third electrical contact 84 is electrically coupled to the second electrical contact 78. Accordingly, while the first finger 70 is in contact with the first electrical contact 72, electrical current may flow through the switch 54 between the first electrical contact 72 and the second and third electrical contacts 78 and 84. Therefore, while the first finger 70 is in contact with the first electrical contact 72, the electrical circuit may be maintained even if contact between the second finger 76 and the second electrical contact 78 is interrupted, thereby increasing the reliability of the switch 54.

While the illustrated embodiment includes the second electrical contact 78 and the third electrical contact 84, it should be appreciated that in alternative embodiments, the second electrical contact or the third electrical contact may be omitted. For example, in certain embodiments, the third electrical contact may be omitted, and the first contact portion of the switch may directly contact the first surface of the circuit board. In further embodiments, the second electrical contact may be omitted, and the electrical current may flow through the switch between the first electrical contact and the third electrical contact. In such embodiments, the second finger of the switch may also be omitted.

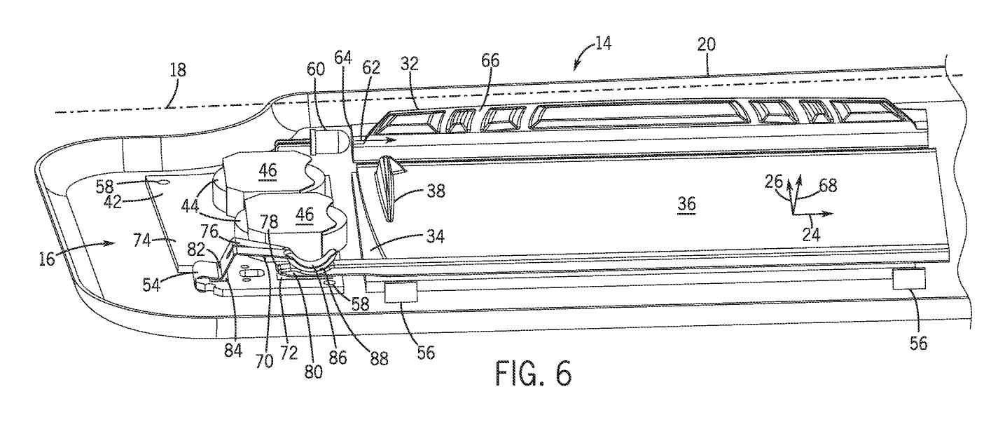

FIG. 6 is a perspective view of a portion of the sun visor 14 of FIG. 3, in which the movable cover 36 is in a closed position. As illustrated, the interrupter element 80 is positioned between the first finger 70 and the first electrical contact 72. Accordingly, the electrical circuit is interrupted, thereby terminating the flow of electrical current to the light source 60. As a result, the light source 60 is deactivated, and light is not emitted from the light guide 32.

In the illustrated embodiment, the first finger 70 includes a curved portion 86 configured to engage a corresponding curved portion 88 of the interrupter element 80. With the curved portion 86 of the first finger 70 engaged with the curved portion 88 of the interrupter element 80, as illustrated, the movable cover 36 is biased toward the closed position. Accordingly, the movable cover 36 is biased toward the closed position while the movable cover 36 is in the closed position. The movable cover 36 may be moved toward the open position by applying a force in the lateral direction 24 sufficient to overcome the bias. As previously discussed, with the movable cover 36 in the open position, the electrical circuit is completed, thereby enabling electrical current to flow from the power source 44 to the light source 60. Because the switch 54 is configured to bias the movable cover 36 to the closed position while the movable cover is in the closed position, a separate detent feature is obviated, thereby reducing the cost and complexity of the vehicle sun visor 14.

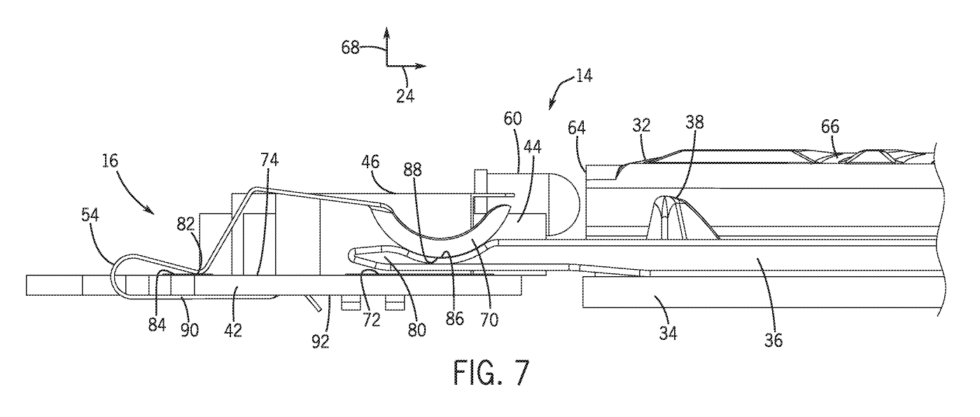

FIG. 7 is a side view of an embodiment of the circuit board 42 and the switch 54 of the lighting system 16. As illustrated, the movable cover 36 is in the closed position, and the curved portion 86 of the first finger 70 is engaged with the curved portion 88 of the interrupter element 80. As a result, the movable cover 36 is biased toward the closed position. In the illustrated embodiment, the switch 54 includes a second contact portion 90. The second contact portion 90 is in contact with a second surface 92 of the circuit board 42 and applies a second force to the second surface 92. As previously discussed, the first contact portion 82 applies a first force to the first surface 74 of the circuit board 42. The first and second contact portions 82 and 90 are biased toward one another to establish the first and second forces, thereby clamping the circuit board 42 between the contact portions of the switch 54. Accordingly, the switch 54 is coupled to the circuit board 42 without utilizing any additional fasteners or adhesives. As a result, the manufacturing cost of the lighting system may be reduced.

In the illustrated embodiment, the circuit board 42 is positioned laterally outward from the reflective element 34, and the reflective element 34 is substantially aligned with the circuit board 42 in the longitudinal direction 68. Accordingly, the thickness of the vehicle sun visor 14 may be reduced, as compared to sun visors that include a circuit board or other components positioned longitudinally behind the reflective element. As a result, headroom within the vehicle interior may be increased, thereby enhancing passenger comfort. In addition, a thinner sun visor may facilitate construction of a vehicle having a lower roofline, thereby increasing fuel efficiency of the vehicle.

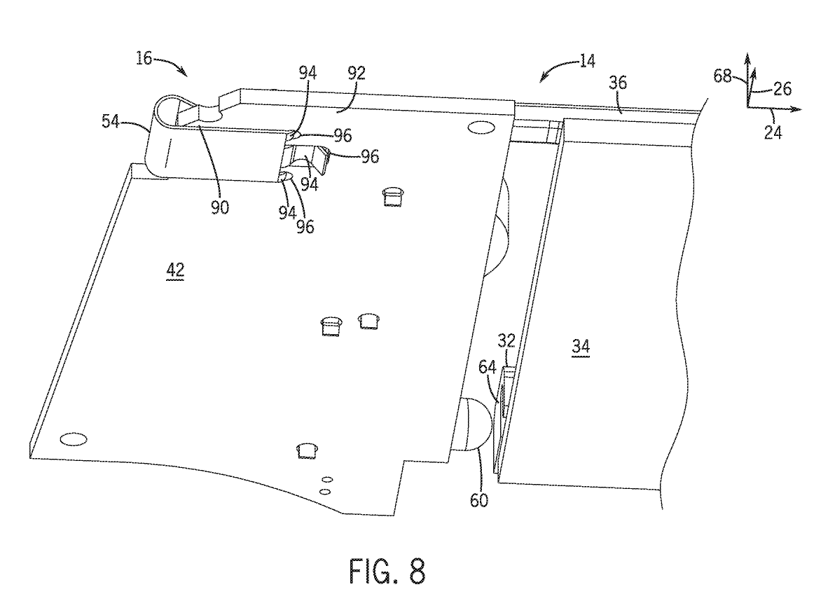

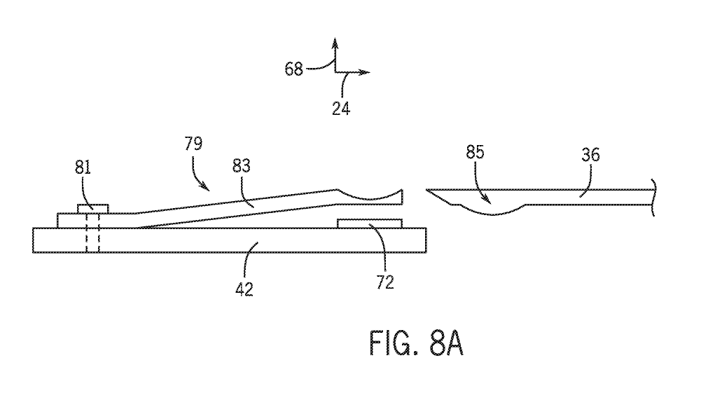

FIG. 8 is a perspective view of the circuit board 42 and the switch 54 of FIG. 7. As illustrated, the second contact portion 90 of the switch 54 is in contact with the second surface 92 of the circuit board 42. As previously discussed, the first and second contact portions establish a clamping force on the circuit board 42 that couples the switch 54 to the circuit board 42. In the illustrated embodiment, the switch 54 includes three retaining features 94 configured to interface with corresponding recesses 96 within the circuit board 42. Engagement of the retaining features 94 with the recesses 96 substantially blocks movement of the switch 54 relative to the circuit board 42, thereby substantially reducing or eliminating the possibility of the switch 54 becoming disengaged from the circuit board 42 (e.g., while the interrupter element is being inserted between the first finger and the first electrical contact). While the illustrated embodiment includes three retaining features 94 and three corresponding recesses 96, it should be appreciated that in alternative embodiments, the switch may include more or fewer retaining features (e.g., 0, 1, 2, 3, 4, or more), and the circuit board may include a corresponding number of recesses.

While the first surface of the circuit board (e.g., the surface onto which the electrical contacts are formed) faces toward the vehicle interior (e.g., toward a vehicle occupant) along the longitudinal direction 68 in the illustrated embodiment, it should be appreciated that in alternative embodiments, the first surface may face away from the vehicle interior (e.g., away from the vehicle occupant). In such embodiments, the fingers of the switch may be configured to engage the electrical contacts on the first surface, and the interrupter element may be positioned behind the first surface relative to the longitudinal direction. Furthermore, while each finger is formed from an electrically conductive material in the illustrated embodiment, it should be appreciated that in alternative embodiments, at least one finger may be formed from an electrically non-conducive material, such as a polymeric material, for example. In such embodiments, an electrical contact may be disposed on an end (e.g., a distal end) of the electrically non-conductive finger. A conductor extending from the electrical contact may be electrically coupled to the power source or to the light source, such that contact between the electrical contact on the finger and the electrical contact on the circuit board completes an electrical circuit that facilitates electrical current flow from the power source to the light source. In certain embodiments, a separate biasing element, such as a coil spring, may urge the electrical contacts into engagement with one another. In further embodiments, other suitable types of fingers/electrical contacts may be utilized, such as a linear rod extending in the longitudinal direction with an electrical contact on a distal end, a pivotal electrically conductive element urged into engagement with the electrical contact on the circuit board by a torsion spring, among others.

FIG. 8A is a schematic view of an alternative embodiment of a switch 79 that may be employed within the lighting system 16. In the embodiment described above with reference to FIGS. 5-8, the switch is coupled to the circuit board by the clamping force applied by the first and second contact portions. However, in the illustrated embodiment, the switch 79 is coupled to the circuit board 42 by a fastener, such as the illustrated bolt 81. In further embodiments, the switch may be coupled to the circuit board by other suitable fastening systems, such as an adhesive (e.g., conductive adhesive) connection, a separate clamp, or a welded connection, among others.

Furthermore, in the embodiment described above with reference to FIGS. 5-8, the first finger is biased toward the circuit board, such that the first finger engages the first electrical contact while the movable cover is in the open position, thereby completing the electrical circuit. However, in the illustrated embodiment, a finger 83 (e.g., electrically conductive finger, etc.) of the switch 79 is biased away from the circuit board 42 in the longitudinal direction 68. An electrical circuit including the switch 79 is interrupted while the finger is disengaged from a respective electrical contact 72 on the circuit board 42, as illustrated. In addition, an element, such as the illustrated driving element 85, extending from the movable cover 36 is configured to drive the finger 83 into engagement with the respective electrical contact 72 on the circuit board 42 while the movable cover 36 is in the closed position, thereby completing the electrical circuit. Electrical circuitry of the sun visor may be configured such that electrical current flows from the power source to the light source while the finger 83 is disengaged from the respective electrical contact 72 (e.g., while the electrical circuit is interrupted), and the electrical current flow from the power source to the light source is interrupted while the finger 83 is engaged with the respective electrical contact 72 (e.g., while the electrical circuit is complete). Accordingly, the light source may be illuminated while the movable cover 36 is in the open position, and the light source may be deactivated while the movable cover 36 is in the closed position.

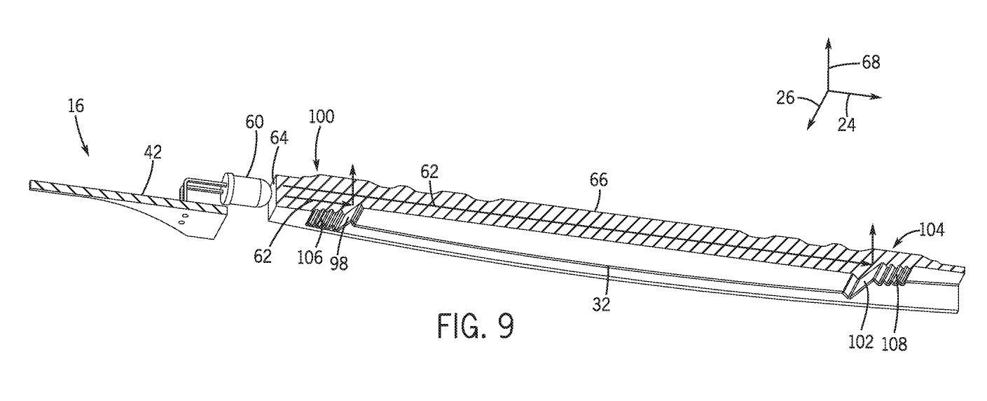

FIG. 9 is a cross-sectional perspective view of an embodiment of the light guide 32. As previously discussed, the light source 60 is configured to emit light 62 in the lateral direction 24 toward the light receiving surface 64 of the light guide 32. In the illustrated embodiment, the light receiving surface 64 corresponds to a lateral end of the light guide 32. The light guide 32 is configured to direct the light from the light receiving surface 64 through the light emitting surface 66, such that the light guide 32 emits light in the longitudinal direction 68 toward the vehicle interior (e.g., toward a vehicle occupant). In the illustrated embodiment, the light guide 32 includes a first reflective surface 98 on a first lateral side 100 of the light guide 32 and a second reflective surface 102 on a second lateral side 104 of the light guide 32, opposite the first lateral side 100. As illustrated, the second reflective surface 102 (e.g., a center point of the second reflective surface 102) is positioned closer to the light emitting surface 66 than the first reflective surface 98 (e.g., a center point of the first reflective surface 98). The first and second reflective surface 98 and 102 are configured to reflect light toward the light emitting surface 66, thereby illuminating the light guide 32.

In the illustrated embodiment, the light guide 32 is formed from a single piece of light transmissive material (e.g., glass, transparent plastic, etc.). Forming (e.g., injection molding, machining, etc.) the light guide 32 from a single piece of material may reduce the cost of the lighting system 16, as compared to a lighting system that includes separately formed reflective surfaces and/or lenses. In certain embodiments, the light is reflected by the reflective surfaces 98 and 102 due to the difference between the refractive index of the light guide 32 and the refractive index of the surrounding air. However, in certain embodiments, a reflective coating (e.g., metallic coating, etc.) may be applied to the exterior surface of the light guide at the reflective surfaces to enhance the reflectivity of the reflective surfaces.

In the illustrated embodiment, the light guide 32 includes a first light dissipating element 106 positioned proximate to the first reflective surface 98 and a second light dissipating element 108 positioned proximate to the second reflective surface 102. The light dissipating elements 106 and 108 are configured to dissipate a portion of the light 62, thereby illuminating a larger area of the light emitting surface 66. While the illustrated embodiment includes two light dissipating elements 106 and 108, it should be appreciated that in alternative embodiments, the light guide may include more or fewer light dissipating elements (e.g., 0, 1, 2, 3, 4, 5, 6, 7, 8, or more).

In the illustrated embodiment, the first reflective surface 98 is angled about 45 degrees relative to the light receiving surface 64, and the second reflective surface 102 is angled about 45 degrees relative to the light receiving surface 64. However, it should be appreciated that in alternative embodiments, the angle of the first reflective surface 98 and/or the angle of the second reflective surface 102 may be greater or less than 45 degrees. For example, in certain embodiments, the first reflective surface and/or the second reflective surface may be angled 10 to 80 degrees, 20 to 70 degrees, 30 to 60 degrees, or 40 to 50 degrees relative to the light receiving surface 64.

The two reflective surfaces 98 and 102 enable the light guide 32 to receive light from the single light source 60 (e.g., a single LED) and to emit light from two separate areas of the light guide 32, thereby establishing two apparent light sources. Because the lighting system 16 includes the single light source 60, the manufacturing cost of the lighting system 16 may be reduced, as compared to a lighting system that utilizes two separate light sources to emit light from two separate areas of the sun visor. While the illustrated embodiment include two reflective surfaces, it should be appreciated that in alternative embodiments, the light guide 32 may include more or fewer reflective surfaces (e.g., 1, 2, 3, 4, 5, 6, or more), thereby providing a corresponding number of apparent light sources.

In the illustrated embodiment, the light source 60 is positioned laterally outward from the light receiving surface 64 of the light guide 32 and is configured to emit light 62 toward the light receiving surface 64. Accordingly, the thickness of the vehicle sun visor may be reduced, as compared to sun visors having a high-profile light source positioned longitudinally behind a light guide or a lens. As a result, headroom within the vehicle interior may be increased, thereby enhancing passenger comfort. In addition, the thinner sun visor may facilitate construction of a vehicle having a lower roofline, thereby increasing fuel efficiency of the vehicle.

In alternative embodiments, a low-profile light source may be positioned longitudinally behind the light guide or disposed within the light guide. For example, in certain embodiments, the light source may include a low-profile surface mount LED (e.g., a single surface mount LED) mounted to the circuit board and configured to emit light in the longitudinal direction. A portion of the light guide (e.g., a portion of the first lateral side of the light guide having the light receiving surface) may be positioned longitudinally forward of the surface mount LED such that the light from the surface mount LED enters the light guide in the longitudinal direction. The light guide may include a third reflective surface configured to reflect the light in the lateral direction, thereby directing the light toward the first and second reflective surfaces. In embodiments in which the light guide is formed from a single piece of light transmissive material, the third reflective surface may be integrally formed within the light guide. Because a low-profile light source (e.g., surface mount LED) is employed to illuminate the light guide, the thickness of the lighting system may be reduced, as compared to lighting systems in which a higher-profile light source is positioned longitudinally behind the light guide. Furthermore, in certain embodiments, a cavity may be formed in the light guide longitudinally behind the third reflective surface, thereby enabling the surface mount LED to be disposed within the cavity. As a result, the thickness of the lighting system may be further reduced.

As described above, the power source is configured to provide electrical power to the light source. As a result, an electrical connection between the sun visor and the vehicle electrical system is obviated. However, it should be appreciated that in alternative embodiments, the light source may receive electrical power from the vehicle electrical system alone or in combination with the power source. In further embodiments, the lighting system (e.g., the circuit board) may be communicatively coupled to the vehicle control system, thereby enabling the vehicle control system to control the sun visor lighting system. Furthermore, while a removable power source is described above, it should be appreciated that in certain embodiments, the power source may be non-removable (e.g., soldered to the circuit board). In such embodiments and/or embodiments in which the light source receives electrical power only from the vehicle electrical system, the power source door may be omitted.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A lighting system for a vehicle sun visor, comprising:
a circuit board having a first surface and a second surface, opposite the first surface, wherein an electrical contact is formed on the first surface; and
a switch having a finger, wherein the finger is biased toward the electrical contact and configured to engage the electrical contact to complete an electrical circuit, and the finger is configured to be separated from the electrical contact via disposition of an element between the finger and the electrical contact to interrupt the electrical circuit, or wherein the finger is biased away from the electrical contact to interrupt the electrical circuit, and the element is configured to drive the finger into engagement with the electrical contact to complete the electrical circuit;
wherein the element extends from a movable cover, the element is configured to engage the finger while the movable cover is in a closed position that covers a reflective element, and the element is configured to disengage the finger while the movable cover is in an open position that exposes at least a portion of the reflective element.

2. The lighting system of claim 1, wherein the switch has a first contact portion and a second contact portion, and the first and second contact portions are biased toward one another such that the first contact portion applies a first force to the first surface of the circuit board, and the second contact portion applies a second force to the second surface of the circuit board to couple the switch to the circuit board.

3. The lighting system of claim 2, wherein the switch is formed from a single piece of material.

4. The lighting system of claim 2, wherein the switch includes at least one retaining feature configured to interface with at least one corresponding recess within the circuit board.

5. The lighting system of claim 1, comprising a power source and a light source, wherein the power source is configured to provide electrical power to the light source, and the power source, the light source, or a combination thereof, are mounted to the circuit board.

6. The lighting system of claim 5, comprising a light guide configured to receive light from the light source and to emit light from a light emitting surface of the light guide.

7. The lighting system of claim 1, wherein the finger includes a curved portion configured to engage a corresponding curved portion of the element to bias the movable cover into the closed position while the movable cover is in the closed position.

8. The lighting system of claim 1, wherein a second electrical contact is formed on the first surface of the circuit board, the switch comprises a second finger biased toward the second electrical contact, and the switch is configured to conduct electrical current between the electrical contact and the second electrical contact to complete the electrical circuit while the finger is engaged with the electrical contact.

9. A lighting system for a vehicle sun visor, comprising:
a light guide having a first reflective surface on a first lateral side of the light guide and a second reflective surface on a second lateral side of the light guide, opposite the first lateral side, the second reflective surface is positioned closer to a light emitting surface of the light guide than the first reflective surface, the light guide is configured to receive light through a light receiving surface on the first lateral side of the light guide, and the first reflective surface and the second reflective surface are configured to reflect the light though the light emitting surface.

10. The lighting system of claim 9, wherein the light guide is formed from a single piece of light transmissive material.

11. The lighting system of claim 9, wherein the first reflective surface is angled at about 45 degrees relative to the light receiving surface, the second reflective surface is angled at about 45 degrees relative to the light receiving surface, or a combination thereof.

12. The lighting system of claim 9, comprising a light source positioned laterally outward from the light receiving surface, wherein the light source is configured to emit the light toward the light receiving surface.

13. The lighting system of claim 9, wherein the light receiving surface corresponds to a lateral end of the light guide.

14. The lighting system of claim 9, wherein the light guide comprise a first light dissipating element positioned proximate to the first reflective surface, a second light dissipating element positioned proximate to the second reflective surface, or a combination thereof.

15. A vehicle sun visor, comprising:
a reflective element;
a movable cover configured to cover the reflective element while in a closed position and to at least partially expose the reflective element to a vehicle interior while in an open position; and
a lighting system comprising a light transmissive element configured to emit light from a light emitting surface of the light transmissive element, wherein the light emitting surface is exposed to the vehicle interior while the movable cover is in the closed position and in the open position.

16. The vehicle sun visor of claim 15, wherein the lighting system comprises:
a circuit board;
a power source electrically coupled to the circuit board; and
a light source electrically coupled to the circuit board;
wherein the light transmissive element comprises a light guide, and the light guide is configured to receive the light from the light source through a light receiving surface on a lateral side of the light guide and to direct the light through the light emitting surface.

17. The vehicle sun visor of claim 16, wherein the circuit board is positioned laterally outward from the reflective element, and the reflective element is substantially longitudinally aligned with the circuit board.

18. The vehicle sun visor of claim 17, wherein the light guide is positioned longitudinally forward of the movable cover.

19. The vehicle sun visor of claim 16, comprising a bezel having a show surface facing the vehicle interior, wherein the bezel includes a recess, and the light guide is positioned within the recess of the bezel.

20. The vehicle sun visor of claim 16, comprising a power source door configured to block access to the power source while in a closed position and to facilitate access to the power source while in an open position, wherein the power source door is separate from the light guide.
